(19) United States
(12) Patent Application Publication
(10) Pub. No.: US 2012/0178299 A1
(43) Pub. Date: Jul. 12, 2012

(54) SURFACE-MOUNT ON-BOARD DIAGNOSTICS CONNECTOR-PIN ASSEMBLY

(75) Inventors: Wes Neibaur, Flower Mound, TX (US); Scott Houston Yarberry, Allen, TX (US)

(73) Assignee: ENFORA, Richardson, TX (US)

(21) Appl. No.: 13/349,473

(22) Filed: Jan. 12, 2012

Related U.S. Application Data
(60) Provisional application No. 61/432,133, filed on Jan. 12, 2011.

(51) Int. Cl. H01R 24/28

(52) U.S. Cl. 439/626

(57) ABSTRACT

A connector-pin assembly includes a frame and a plurality of pins. The frame includes a plurality of slots. The plurality of pins is insertable into the plurality of slots and are configured to provide an electrical connection between an on-board-diagnostic vehicle connector and a circuit board. The plurality of slots is configured to align the plurality of pins with connectors in the on-board-diagnostic vehicle connector.

### CROSS-REFERENCE TO RELATED APPLICATION(S) AND CLAIM OF PRIORITY

The present application is related to U.S. Provisional Patent Application No. 61/432,133, filed Jan. 12, 2011, entitled “SURFACE MOUNT ON-BOARD-DIAGNOSTICS CONNECTOR PIN ASSEMBLY”. Provisional Patent Application No. 61/432,133 is hereby incorporated by reference into the present application as if fully set forth herein. The present application hereby claims priority under 35 U.S.C. §119(e) to U.S. Provisional Patent Application No. 61/432,133.

### TECHNICAL FIELD

Generally, this disclosure relates to electrical connections between components, and, more specifically, to a surface-mount connector-pin assembly for on-board-diagnostics.

### BACKGROUND

On-Board Diagnostics (OBD) refers to a vehicle's self-diagnostic and reporting capability. OBD systems give users access to information for various vehicle sub-systems. OBD-II is a current standard interface for OBD systems.

SAE International® publishes a standard for a vehicle connector for OBD-II systems in the J1962 standards document. According to this standard, the vehicle connector is a female connector mounted in a vehicle, and includes sixteen conductors and receptacles adapted to receive pins from external equipment. The pins of the external equipment can be inserted into the vehicle connector to receive a range of diagnostic information from the vehicle. The SAE International® J1962 standards document is available online from SAE International and is incorporated herein by reference.

Some designs for pins on external equipment have used molded plugs with pins or used single pins that have been through-hole soldered at right angles to the circuit board. Fabrication and/or use of molded plugs and through-hole soldered pins can be time consuming and require hand soldering. Additionally, such pins can be difficult to align in the specified locations to match the mating receptacle of the vehicle connector.

Accordingly, there is a need for systems and methods that address the above described issues and possibly other issues. For example, there is a need for a surface-mount on-board-diagnostics connector-pin assembly.

### SUMMARY

In one embodiment of the present disclosure, a connector-pin assembly includes a frame and a plurality of pins. The frame includes a plurality of slots. The plurality of pins is insertable into the plurality of slots. The plurality of pins is configured to provide an electrical connection between an on-board-diagnostic vehicle connector and a circuit board. The plurality of slots is configured to align the plurality of pins with connectors in the on-board-diagnostic vehicle connector.

In another embodiment of the present disclosure, system for receiving diagnostic information is provided. The system includes electrical circuitry and a connector-pin assembly. The electrical circuitry includes a circuit board. The electrical circuitry is configured to process the diagnostic information. The connector-pin assembly includes a frame and a plurality of pins inserted into a plurality of slots in the frame. The plurality of pins is configured to provide an electrical connection between an on-board-diagnostic vehicle connector and the circuit board. The plurality of slots is configured to align the plurality of pins with connectors in the on-board-diagnostic vehicle connector.

In yet another embodiment of the present disclosure, a method for connecting a connector-pin assembly is provided. The method includes inserting a plurality of pins into a plurality of slots in a frame. The plurality of slots is configured to align the plurality of pins with connectors in an on-board-diagnostic vehicle connector. The method also includes connecting an end of each of the plurality of pins to a circuit board. The plurality of pins is configured to provide an electrical connection between the on-board-diagnostic vehicle connector and the circuit board.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a connector-pin assembly assembled in accordance with an illustrative embodiment of the present disclosure;

FIG. 2 illustrates an exploded view of a connector-pin assembly in accordance with an illustrative embodiment of the present disclosure;

FIG. 3 illustrates a view of one side of a connector-pin assembly in accordance with an illustrative embodiment of the present disclosure;

FIG. 4 illustrates a view of another side of a connector-pin assembly in accordance with an illustrative embodiment of the present disclosure;

FIG. 5 illustrates a connector-pin assembly connected to a circuit board in accordance with one embodiment of the present disclosure;

FIG. 6 illustrates a connector-pin assembly connected to a circuit board in accordance with another embodiment of the present disclosure; and

FIG. 7 illustrates a process for connecting a connector-pin assembly in accordance with an illustrative embodiment of the present disclosure.

### DETAILED DESCRIPTION

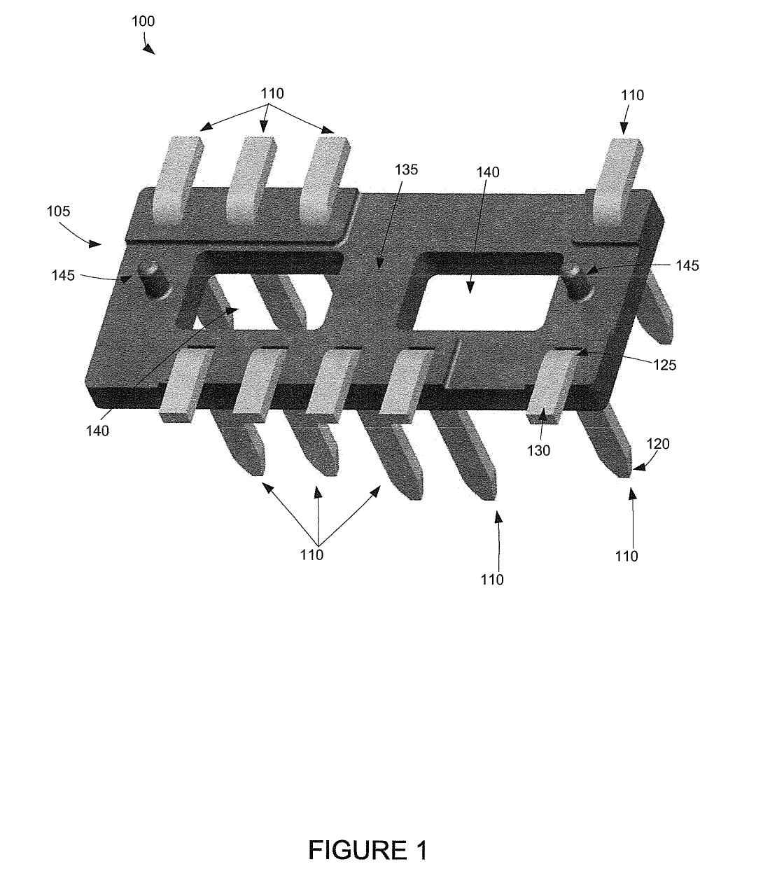

FIGS. 1 through 7, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any type of suitably arranged device or system.

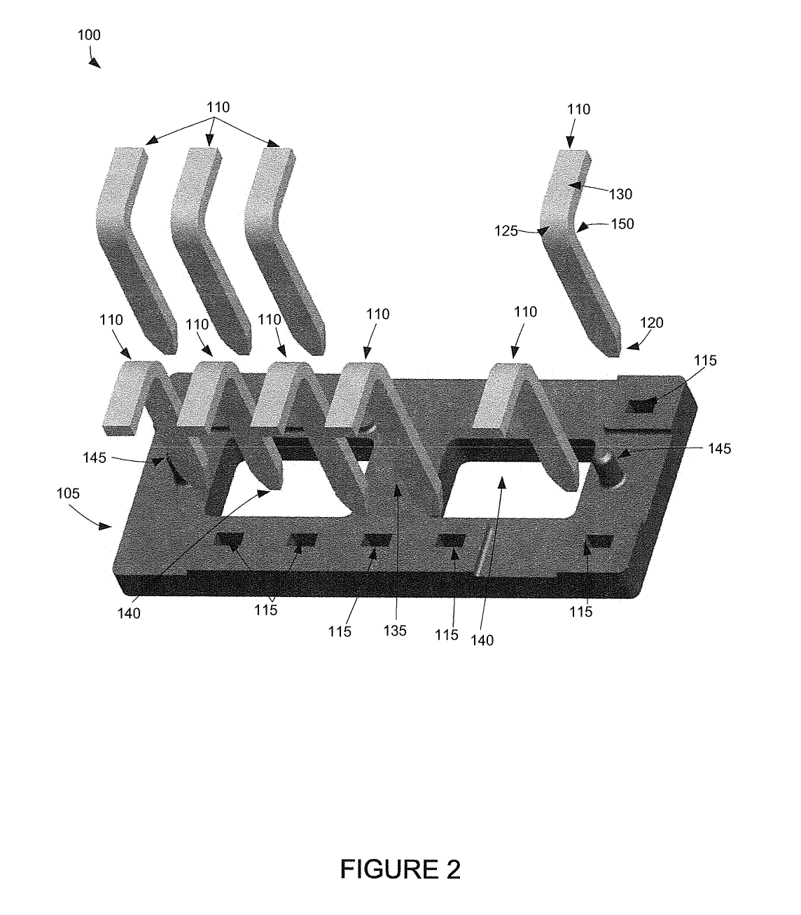

FIGS. 1-4 illustrate various views of a pin-connector assembly 100 in accordance with illustrative embodiments of the present disclosure. Referring to FIGS. 1-4, the pin-connector assembly 100 includes a frame 105 and a plurality of pins 110. As illustrated, for example, in FIG. 2, the pins 110 are insertable into a plurality of slots 115 in the frame 105.

The slots 115 in the frame 105 are matched with receptacles in a vehicle connector (e.g., an OBD vehicle connector) (not shown). Specifically, the slots 115 provide a guide for each of the pins 110 to be inserted into and mated with a receptacle (socket) or lead of the vehicle connector. In these illustrative examples, the pin-connector assembly 100 includes nine slots and pins. However, in other embodiments any different number of slots and pins may be used. For example, the frame 105 may include sixteen slots, one for each of the sockets/connectors in a standard vehicle connector, while the pin-connector assembly 100 includes a number of pins selected based on configuration of pin contacts desired for a particular use.

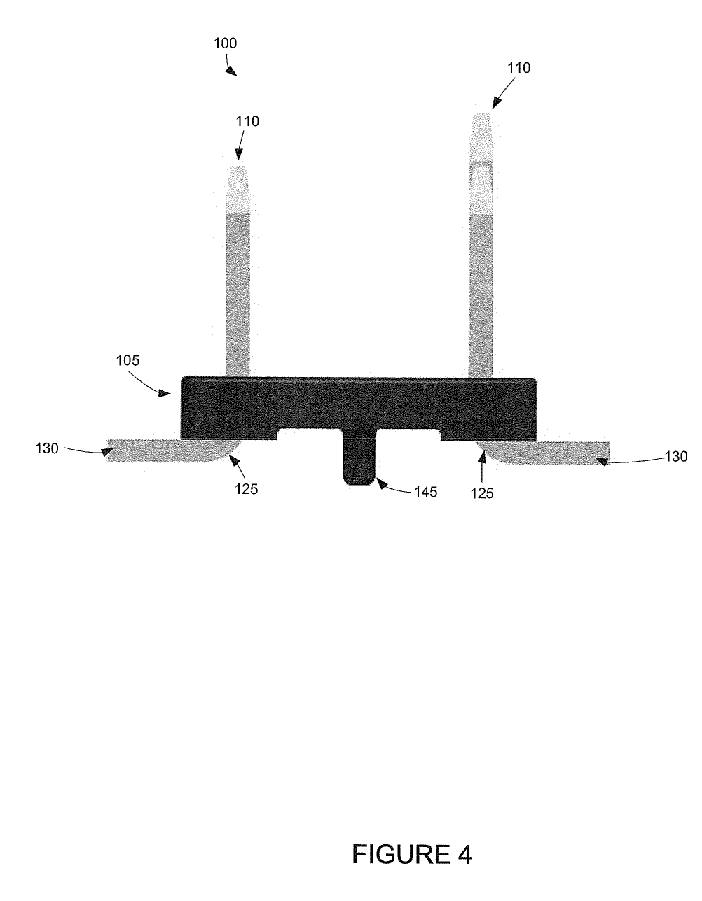

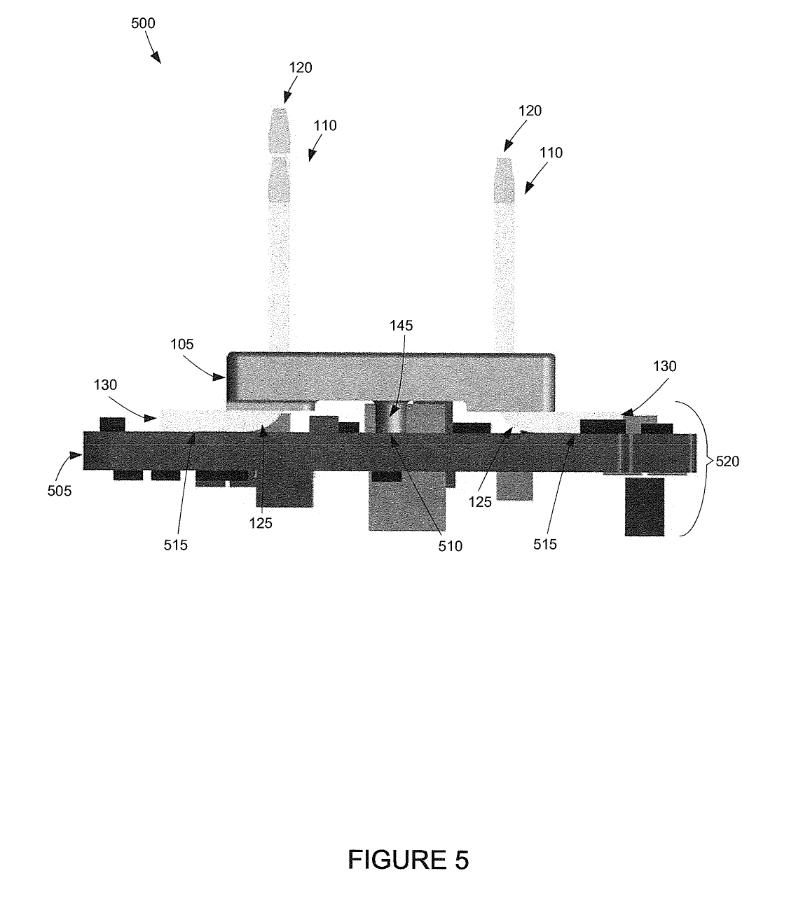

In these illustrative embodiments, each of the pins 110 includes a tip 120, a bent portion 125, and a connector portion 130. The tip 120 is configured to be inserted into and mated with a receptacle or socket of a vehicle connector. The connector portion 130 provides an electrical contact for a circuit board (e.g., the circuit board 505 in FIG. 5). The bent portion 125 extends the connector portion 130 outwardly from the frame 105. As illustrated, for example, in FIG. 4, the connector portion 130 extends outwardly from the frame 105, which may allow for ease of mounting and soldering onto the circuit board 505 in a surface-mount technology (SMT) production process.

One of the innovative elements of the present disclosure is the ability to surface mount a connector for the OBD II interface. For example, pin-connector assembly 100 may be surface mounted and soldered onto the circuit board 505 in a SMT production process. The frame 105 is composed of material that can withstand temperatures of the SMT production process. For example, reflow soldering during the SMT production process may involve temperatures exceeding 260° C.

In some embodiments, the frame 105 includes a flat portion 135 positioned between open portions 140 in the frame 105. For example, the flat portion 135 may allow a machine (e.g., a pick-and-place machine) the ability to pick-up and place the pin-connector assembly 100. For example, the machine may be able to pick-up the pin-connector assembly 100 using the flat portion 135 and then place the pin-connector assembly 100 onto the circuit board 505 during a SMT production process.

In various embodiments, the frame 105 also includes one or more alignment posts or structures 145 (two shown). The alignment posts 145 aid in mounting and aligning the pin-connector assembly 100 onto another component, for example, the circuit board 505 as illustrated in FIG. 5. For example, the alignment posts 145 may be mated with holes 510 on the circuit board in a position such that the connector portions 130 of the pins 110 are aligned with contacts 515 on the circuit board 505.

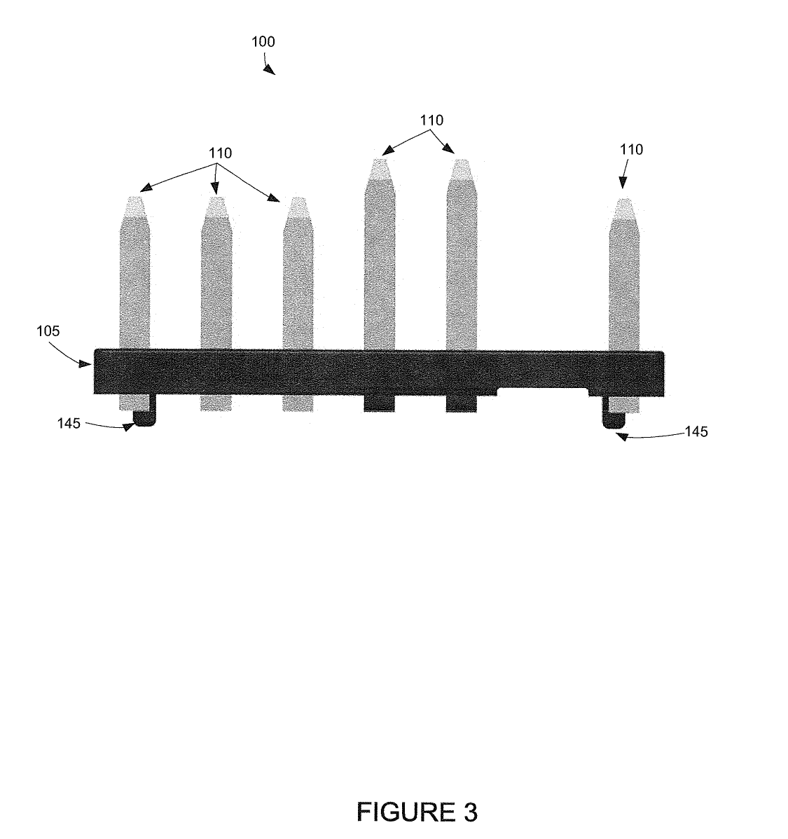

As illustrated, for example, in FIGS. 3 and 4, the pins 110 may have different lengths. In one example, some pins may be longer so that grounded contacts mate first. In another example, the pins 110 that protrude through the frame 105 are fitted to be substantially similar to the dimensions of the frame 105. In another example, an exterior dimension of the pins 110 is smaller than the holes in the frame. In some embodiments, the pins 110 may be held in place through a groove 150 that matches the frame 105. In other embodiments, the pins 110 may be held in place through magnetic forces or adhesive forces.

FIG. 5 illustrates the connector-pin assembly 100 connected to the circuit board 505 in accordance with one embodiment of the present disclosure. In this illustrative example, an external device 500 includes the connector-pin assembly 100 connected to the circuit board 505. The external device 500 may be connected with an OBD vehicle connector (through the connector-pin assembly 100) to retrieve information from a vehicle. The external device 500 includes hardware, software and/or firmware, or a combination thereof, that includes functionality and is configured to transmit/receive electrical signals to/from the OBD vehicle connector. Though not shown, in an application, the external device 500 is connected to the ODB vehicle connector (not shown).

The connection of the connector-pin assembly 100 with the circuit board 505 enables or allows the circuit board 505 to be used as an interface between the OBD data bus in a vehicle and electrical circuitry 520 external to the vehicle. For example, the electrical circuitry 520 may include one or more receivers, transmitters, data processing systems, diagnostic devices, application specific integrated circuits (ASICs), and/or any other type of electrical circuitry suitable for retrieving and using information from a vehicle. For example, in some embodiments, the circuit board 505 may be a host for additional electrical circuitry that may be connected to and/or plugged into the circuit board 505.

In this illustrative embodiment, the bent portion 125 in the pins 110 extends the connector portion 130 outwardly from the frame 105. For example, the connector portions 130 of the pins 110 may extend in a direction that is substantially parallel to the circuit board 505. The connector portions 130 of the pins 110 may extend in a direction that is substantially perpendicular to a direction of the tips 120 of the pins 110. The extension of the connector portions 13n extend outwardly from the frame 105, which may allow for ease of mounting and soldering onto the circuit board 505 in a SMT production process.

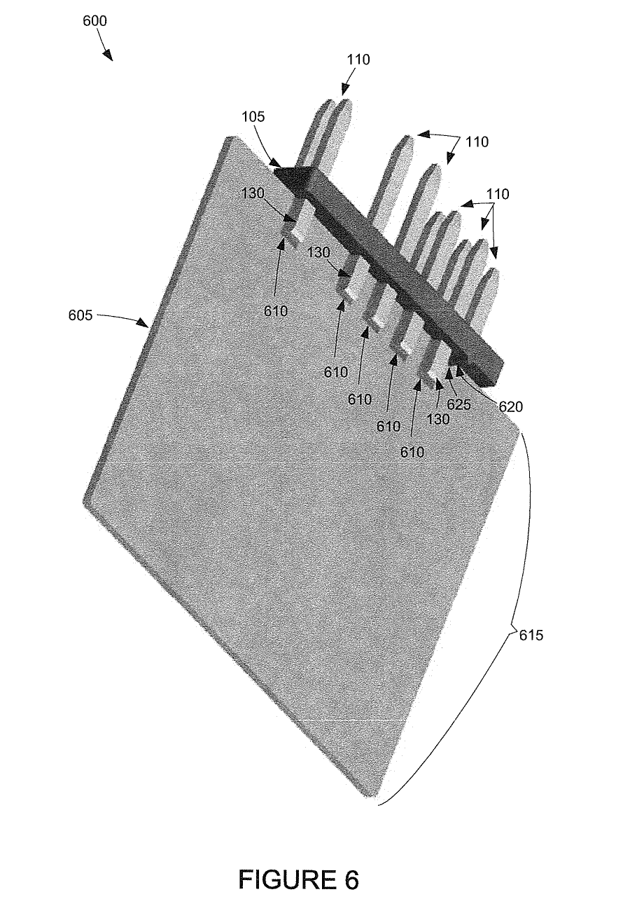

FIG. 6 illustrates the connector-pin assembly 100 connected to a circuit board 605 in accordance with another embodiment of the present disclosure. In this illustrative example, an external device 600 includes the connector-pin assembly 100 connected to the circuit board 605. In this embodiment, the pins 110 extend in a direction that is substantially parallel to the circuit board 605, while the circuit board 605 is substantially perpendicular to the frame 105. For example, in this illustrative embodiment the pins 110 may be substantially straight.

In this illustrative embodiment, the connector portion 130 of the pins 110 is connected to the contacts 610 of the circuit board 605. For example, the connector portion 130 may be connected to the contacts 610 of the circuit board 605 using soldering reflow during a SMT production process. The electrical circuitry 615 is an example of one implementation of the electrical circuitry 520 in FIG. 5.

In this embodiment, the connector-pin assembly 100 includes one or more alignment posts or structures 620. The alignment posts 620 may be used for a similar purpose as the alignment posts 145 in FIG. 5. For example, the alignment posts 145 may mate with slots 625 on the circuit board 605 in a position such that the connector portions 130 of pins 110 are aligned with the contacts 610 on the circuit board 605.

The illustrations of the connector-pin assembly 100 and the external devices 500 and 600 are not meant to imply physical or architectural limitations to the manner in which different illustrative embodiments may be implemented. Other components in addition to and/or in place of the ones illustrated may be used. Some components may be unnecessary in some illustrative embodiments.

For example, the innovative elements of the present disclosure may be applied to surface mount any kind of connector using a frame and removable pin system. Any mobile test or permanent application desiring access to a vehicle connector may be used in accordance with the present disclosure.

In some embodiments, the frame 105 may be removed after the pins 110 are surface mounted; thus, the external devices 500 and 600 may not include the frame 105. In yet another embodiment, the frame 105 may act as a guide for the connector to fit into another receptacle, such as a plug. For example, the frame 105 may have one or more openings that are designed to promote the connection of the connector based upon the intended use of the connector.

In other embodiments, the frame 105 may include one or more pins which are conductive and built into the frame. In yet other embodiments, the frame may have a plurality of holes to promote connections with various types or configurations of plugs, including those contemplated in the SAE International® J1962 standards document. However, the size and dimensions of the frame 105 and the pins 110 may be adjusted to fit into any type or configuration of plug using any standard.

In still other embodiments, the pins may have a rounded edge or a flat edge at the base of the ninety-degree bend. In still yet other embodiments, the pins may have a less than 90 degree angle or a greater than 90 degree angle.

In other embodiments, two or more pins may be connected together such that a single surface mount point or pad can be electrically connected to two or more pins. In still other embodiments, all or part of the frame 105 may have a ground connection and one or more pins 110 may have a ground connection tied to the frame 105.

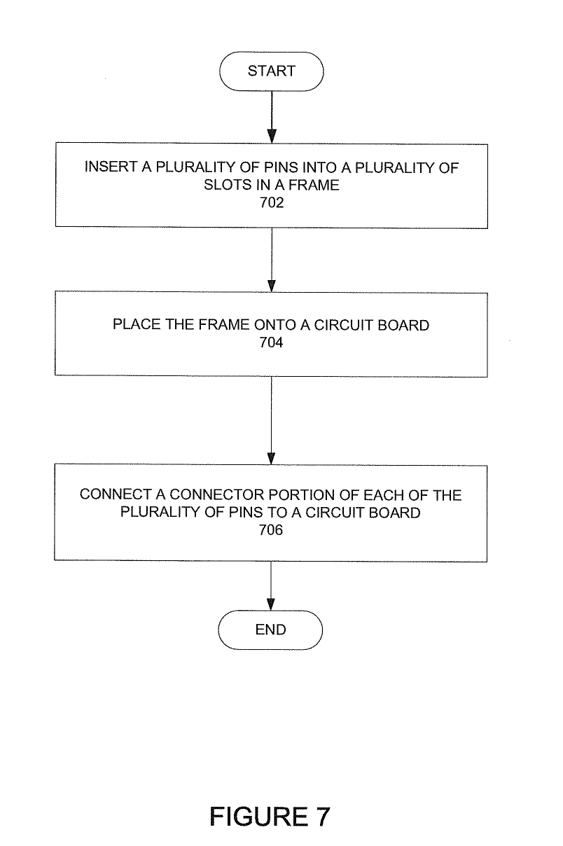

FIG. 7 illustrates a process for connecting a connector-pin assembly in accordance with an illustrative embodiment of the present disclosure. The process illustrated in FIG. 7 may be performed by a machine (e.g., a pick-and-place machine) during a SMT production process. In some embodiments, the process may be performed during a single production process. In other embodiments, one or more steps in the process may be performed as part of separate processes.

The process begins by inserting a plurality of pins into a plurality of slots in a frame (step 702). In step 702, the slots may be configured to align the plurality of pins with connectors in an on-board-diagnostic vehicle connector.

The process then places the frame onto a circuit board (step 704), such as circuit board 505 or 605. In step 704, the frame may include a flat portion between open spaces in the frame. The flat portion may allow a machine to pick up and place the frame onto the circuit board 505, 605. The frame may also include one or more alignment posts or structures, and for example, may include alignment posts at opposite ends of the frame. The alignment posts allow the machine to precisely mount the frame onto the circuit board 505, 605, such that connector portions of the pins are aligned with contacts on the circuit board.

Thereafter, the process electrically connects the connector portion 130 of each of the plurality of pins 110 to pads on the circuit board (step 706). In step 706, the pins 110 may be soldered to the circuit board using a solder reflow process, and the pins 110 provide an electrical connection between the on-board-diagnostic vehicle connector and the circuit board. A tip of each of the plurality of pins may then be inserted into an on-board-diagnostic vehicle connector such that information may be received from the vehicle.

The illustrative embodiments of the present disclosure provide a connector-pin assembly that can be surface mounted and is connectable to an OBD vehicle connector. The frame of the connector-pin assembly aligns the pins of the connector-pin assembly with the leads in the OBD vehicle connector. Additionally, the ability to surface mount the connector-pin assembly to a circuit board in as SMT production process can reduce the amount of time and cost to produce a physical interface for an OBD vehicle connector.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a frame including a plurality of slots; and
a plurality of pins insertable into the plurality of slots, the plurality of pins configured to provide an electrical connection between an on-board-diagnostic vehicle connector and a circuit board,
wherein the plurality of slots is configured to align the plurality of pins with a plurality sockets in the on-board-diagnostic vehicle connector.

2. The apparatus of claim 1, wherein at least one pin in the plurality of pins includes a tip extending from a first side of the frame adapted to be inserted into a connector of the on-board-diagnostic vehicle connector and a second portion extending from a second side of the frame.

3. The apparatus of claim 2, wherein the second portion includes a connector portion adapted to be soldered to the circuit board.

4. The apparatus of claim 2, wherein the second portion of the one pin includes a bent portion and a connector portion, wherein the second portion extends from the second side of the frame at an angle such that the connector portion of the second portion extends in a direction that is substantially parallel with the second side.

5. The apparatus of claim 2, wherein the second portion extends from the second side of the frame in a direction that is substantially perpendicular with the second side.

6. The apparatus of claim 2, wherein one pin in the plurality of pins further includes a groove configured to hold the one pin in place in a slot of the frame.

7. The apparatus of claim 1, wherein the frame further comprises a flat portion between open spaces in the frame, wherein the flat portion is configured to allow a machine to pick up and place the frame during a surface-mount technology production process.

8. The apparatus of claim 1, wherein the frame further includes a pair of alignment posts, one alignment post at opposite ends of the frame, wherein the pair of alignment posts are configured to allow mounting of the frame during a surface-mount technology production process.

9. The apparatus of claim 1, wherein one pin in the plurality of pins extends further from a first side of the frame than another pin.

10. The apparatus of claim 1, wherein an arrangement of the plurality of pins conforms to an on-board-diagnostics (OBD) II standard.

11. A system for receiving diagnostic information, the system comprising:
electrical circuitry including a circuit board, the electrical circuitry configured to process the diagnostic information; and
a connector-pin assembly including a frame and a plurality of pins inserted into a plurality of slots in the frame, wherein the plurality of pins are configured to provide an electrical connection between an on-board-diagnostic vehicle connector and the circuit board and wherein the plurality of slots is configured to align the plurality of pins with connectors in the on-board-diagnostic vehicle connector.

12. The system of claim 11, wherein at least one pin in the plurality of pins includes a tip extending from a first side of the frame adapted to be inserted into a connector of the on-board-diagnostic vehicle connector and a second portion extending from a second side of the frame, wherein the second portion includes a connector portion soldered to the circuit board.

13. The system of claim 12, wherein the second portion of the one pin includes a bent portion and a connector portion, wherein the second portion extends from the second side of the frame at an angle such that the connector portion of the second portion is substantially parallel with the second side.

14. The system of claim 12, wherein the second portion extends from the second side of the frame in a direction that is substantially perpendicular with the second side.

15. The system of claim 11, wherein the frame further includes a pair of alignment posts, one alignment post at opposite ends of the frame, wherein the pair of alignment posts are configured to allow mounting of the connector-pin assembly during a surface-mount technology production process.

16. The system of claim 11, wherein the connector-pin assembly further includes a flat portion between open spaces in the frame, wherein the flat portion is configured to allow a machine to pick up and place the connector-pin assembly in a surface-mount technology production process.

17. A method for connecting a connector-pin assembly, the method comprising:
inserting a plurality of pins into a plurality of slots in a frame, wherein the plurality of slots is configured to align the plurality of pins with connectors in an on-board-diagnostic vehicle connector; and
connecting an end of each of the plurality of pins to a circuit board, wherein the plurality of pins is configured to provide an electrical connection between the on-board-diagnostic vehicle connector and the circuit board.

18. The method of claim 17, wherein connecting the end of each of the plurality of pins to the circuit board comprises:
soldering the end of each of the plurality of pins to the circuit board, wherein the end of each of the plurality of pins extends in a direction that is substantially parallel to the circuit board.

19. The method of claim 17 further comprising:
mounting the frame onto the circuit board using a pair of alignment posts on the frame, one alignment post at opposite ends of the frame, during a surface-mount technology production process.

20. The method of claim 17 further comprising:
positioning, using a machine, the connector-pin assembly using a flat portion between open spaces in the frame during a surface-mount technology production process.
